(19) United States
(12) Patent Application Publication
(10) Pub. No.: US 2006/0087753 A1
(43) Pub. Date: Apr. 27, 2006

(54) Portable Mirror Apparatus

(76) Inventor: Michelle De Sousa, Naples, FL (US)

Correspondence Address: Jose De Sousa, P.O. Box 111585, Naples, FL, 34108, US

(21) Appl. No.: 10/904,076

(22) Filed: Oct. 21, 2004

(51) Int. Cl. G02B 7/182

(52) U.S. Cl. 359/871; 359/860

(57) ABSTRACT

A expandable portable mirror apparatus that is used as an attachment to the body to assist in hands free hair removal.

A portable mirror apparatus that is used as an attachment to the body to assist in hands free hair removal. This is utilized by a mirror that is attached to a spiral or circular material which is expandable to fit the body area.

The apparatus allows hands free usage portable mirror can be used to assist for under arm, eyebrows, pelvic area or any area where necessary for hair removal.

What is claimed is:

1. What is claimed is a mirror apparatus that is attached to the body to assist in hair removal.
